(19) United States
(12) Patent Application Publication
(10) Pub. No.: US 2016/0094822 A1
(43) Pub. Date: Mar. 31, 2016

(54) IMAGING DEVICE, IMAGE PROCESSING DEVICE, IMAGING METHOD, AND IMAGE PROCESSING METHOD

(71) Applicant: OLYMPUS CORPORATION, Tokyo (JP)

(72) Inventor: Shinichi IMADE, Iruma-Shi (JP)

(73) Assignee: OLYMPUS CORPORATION, Tokyo (JP)

(21) Appl. No.: 14/962,388

(22) Filed: Dec. 8, 2015

Related U.S. Application Data
(63) Continuation of application No. PCT/JP2014/062295, filed on May 8, 2014.

(30) Foreign Application Priority Data
Jun. 21, 2013 (JP) 2013-130963

(51) Int. Cl. H04N 9/64; G02B 5/20; H04N 9/04

(52) U.S. Cl. CPC H04N 9/64; H04N 9/045; G02B 5/201

(57) ABSTRACT

An imaging device includes an optical filter, an image sensor, a multi-band estimation section, and a processor including hardware. The optical filter divides the pupil of an imaging optics into a first pupil and a second pupil that differs in wavelength passband from the first pupil. The image sensor includes a first-color filter that has first transmittance characteristics, a second-color filter that has second transmittance characteristics, and a third-color filter that has third transmittance characteristics. The processor is configured to implement a multi-band estimation process that estimates component values that respectively correspond to first to fourth bands based on pixel values that respectively correspond to first to third colors that form an image captured by the image sensor, the first to fourth bands being set based on the wavelength passbands of the first pupil and the second pupil, and the first to third transmittance characteristics.

### CROSS REFERENCE TO RELATED APPLICATION

This application is a continuation of International Patent Application No. PCT/JP2014/062295, having an international filing date of May 8, 2014, which designated the United States, the entirety of which is incorporated herein by reference. Japanese Patent Application No. 2013-130963 filed on Jun. 21, 2013 is also incorporated herein by reference in its entirety.

### BACKGROUND

The present invention relates to an imaging device, an image processing device, an imaging method, an image processing method, and the like.

A number of methods that calculate distance information from image information to measure a three-dimensional shape have been proposed. For example, a right-pupil image and a left-pupil image are generated (separated) based on a color component by inserting a color filter at the pupil position to calculate phase difference information, and a three-dimensional measurement process is performed by utilizing the principle of triangulation. In this case, it is necessary to perform a spectral separation process on the captured color image in order to generate (separate) the right-pupil image and the left-pupil image. The spectral separation process is normally performed optically by providing an optical filter that selectively allows the separation target wavelength region to pass through to each pixel of an image sensor. Such a method is disclosed in the following documents, for example.

JP-A-2005-286649 discloses an imaging device that includes five or more color filters that differ in average wavelength with respect to the spectral transmittance characteristics. In JP-A-2005-286649, a first blue filter, a second blue filter, a first green filter, a second green filter, a first red filter, and a second red filter are provided corresponding to the pixels of the image sensor so that a multi-band image can be captured at a time.

JP-A-2005-260480 discloses a method that provides a branch optics between an imaging optics and an image sensor, and separates an image (luminous flux) into four or more wavelength bands using the branch optics. According to the method disclosed in JP-A-2005-260480, an image that corresponds to each color is formed in a separate area on the image sensor. Since the image that corresponds to each color is generated in a separate area, a multi-band image can be captured at a time.

The Journal of the Institute of Electronics, Information and Communication Engineers, Vol. 88, No. 6, 2005 (Tokyo Institute of Technology) discloses a method that acquires a multi-band image by capturing an image while sequentially switching the wavelength passband (passband) using a rotary multi-band filter. According to this method, information about a wavelength band that cannot be acquired is estimated using prior information that represents that the spectral reflectivity of an object in the natural world is smooth.

### SUMMARY

According to one aspect of the invention, there is provided an imaging device comprising:

an optical filter that divides a pupil of an imaging optics into a first pupil and a second pupil, the second pupil differing in wavelength passband from the first pupil;

an image sensor that includes a first-color filter that has first transmittance characteristics, a second-color filter that has second transmittance characteristics, and a third-color filter that has third transmittance characteristics; and

a processor comprising hardware,

the processor being configured to implement a multi-band estimation process that estimates component values that respectively correspond to a first band, a second band, a third band, and a fourth band based on pixel values that respectively correspond to a first color, a second color, and a third color that form an image captured by the image sensor, the first band, the second band, the third band, and the fourth band being set based on the wavelength passband of the first pupil, the wavelength passband of the second pupil, the first transmittance characteristics, the second transmittance characteristics, and the third transmittance characteristics.

According to another aspect of the invention, there is provided an imaging device comprising:

an optical filter that divides a pupil of an imaging optics into a first pupil and a second pupil, the second pupil differing in wavelength passband from the first pupil; and

an image sensor that includes a first-color filter that has first transmittance characteristics, a second-color filter that has second transmittance characteristics, and a third-color filter that has third transmittance characteristics,

the first band and the second band corresponding to a band of the first transmittance characteristics, the second band and the third band corresponding to a band of the second transmittance characteristics, and the third band and the fourth band corresponding to a band of the third transmittance characteristics, and

the first pupil allowing the first band and the fourth band to pass through, and the second pupil allowing the second band and the third band to pass through.

According to another aspect of the invention, there is provided an image processing device comprising:

a processor comprising hardware,

the processor being configured to implement:

an image acquisition process that acquires an image captured by an image sensor, the image sensor including a first-color filter that has first transmittance characteristics, a second-color filter that has second transmittance characteristics, and a third-color filter that has third transmittance characteristics; and

a multi-band estimation process that estimates component values that respectively correspond to a first band, a second band, a third band, and a fourth band based on pixel values that respectively correspond to a first color, a second color, and a third color that form the image,

the first band and the second band corresponding to a band of the first transmittance characteristics, the second band and the third band corresponding to a band of the second transmittance characteristics, and the third band and the fourth band corresponding to a band of the third transmittance characteristics.

According to another aspect of the invention, there is provided an imaging method comprising:

capturing light that has passed through an optical filter using an image sensor, the optical filter dividing a pupil of an imaging optics into a first pupil and a second pupil, the second pupil differing in wavelength passband from the first pupil, and the image sensor including a first-color filter that has first transmittance characteristics, a second-color filter that has second transmittance characteristics, and a third-color filter that has third transmittance characteristics; and

estimating component values that respectively correspond to a first band, a second band, a third band, and a fourth band based on pixel values that respectively correspond to a first color, a second color, and a third color that form an image captured by the image sensor, the first band, the second band, the third band, and the fourth band being set based on the wavelength passband of the first pupil, the wavelength passband of the second pupil, the first transmittance characteristics, the second transmittance characteristics, and the third transmittance characteristics.

### BRIEF DESCRIPTION OF THE DRAWINGS

FIG. 1 illustrates a configuration example of an imaging device.

FIG. 2 illustrates a basic configuration example of an imaging device.

FIG. 3 is a view illustrating a band division method.

FIG. 4 is a schematic view illustrating a change in 4-band component values at an edge.

FIG. 5 is a schematic view illustrating a change in RGB pixel values at an edge.

FIG. 6 is a view illustrating a 4-band component value estimation method.

FIG. 7 is a view illustrating a 4-band component value estimation method.

FIG. 8 is a view illustrating a first estimation method.

FIG. 9 is a view illustrating the relationship between 4-band component values and RGB pixel values.

FIG. 10 is a view illustrating a third estimation method.

FIG. 11 illustrates a detailed configuration example of an imaging device.

FIG. 12 illustrates a detailed configuration example of an image processing device that is provided separately from an imaging device.

FIG. 13 is a view illustrating a monitor image generation process.

FIG. 14 is a view illustrating a complete 4-band phase difference image generation process.

FIG. 15 is a view illustrating a complete 4-band phase difference image generation process.

FIG. 16 is a view illustrating a method that calculates a distance from a phase difference.

### DESCRIPTION OF EXEMPLARY EMBODIMENTS

Several aspects of the invention may provide an imaging device, an image processing device, an imaging method, an image processing method, and the like that can implement a multi-band imaging system without significantly changing an existing imaging system.

Exemplary embodiments of the invention are described in detail below. Note that the following exemplary embodiments do not in any way limit the scope of the invention defined by the claims laid out herein. Note also that all of the elements described below in connection with the exemplary embodiments should not necessarily be taken as essential elements of the invention.

### 1. Outline

A phase detection autofocus (AF) method has been known as a typical high-speed AF method. The phase detection AF method branches the imaging optical path, and detects phase difference information using a dedicated phase difference detection image sensor. In recent years, various methods that detect the phase difference using only a normal image sensor without providing a dedicated image sensor have been proposed. Examples of such methods include a method that provides an image sensor with a phase difference detection function (imager phase detection method), a method that provides filters that differ in wavelength band at the right pupil position and the left pupil position of an imaging optics, acquires right and left phase difference images (multiple images) based on the difference in color, and calculates the phase difference (color phase detection method), and the like.

However, the imager phase detection method has a drawback in that it is necessary to provide independent pixels (phase difference detection pixels) that respectively receive a luminous flux from the right pupil position and a luminous flux from the left pupil position, and the number of pixels that can be used to form an image is halved (i.e., a decrease in resolution occurs). Since pixel defects occur due to the phase difference detection pixels, and deterioration in image quality occurs, an advanced correction process is required.

The color phase detection method disclosed in JP-A-2005-286649 and the color phase detection method disclosed in JP-A-2005-260480 (that does not relate directly to AF) can solve the problems that occur when using the imager phase detection method. However, when using a normal primary-color (RGB) image sensor, it is necessary to assign a red (R) filter to a luminous flux that passes through the right pupil, and assign a blue (B) filter to a luminous flux that passes through the left pupil so that the phase difference images can be separated based on one of the primary colors, for example. Therefore, when the image is a single-color image (i.e., an image that includes only a red component R, or an image that includes only a blue component B), only an image that has passed through the right pupil or the left pupil can be acquired, and it is impossible to detect the phase difference. When the correlation between the R image and the B image is low, the phase difference detection accuracy deteriorates even if the phase difference images can be acquired by color separation. Specifically, the color phase detection method has a drawback in that it may be impossible to detect the phase difference, or the detection accuracy may significantly deteriorate. Since the color phase detection method utilizes a filter that allows only a luminous flux that corresponds to R, G, or B to pass through, a decrease in light intensity occurs. Since a color shift necessarily occurs within the captured image at the defocus position due to the phase difference, it is necessary to perform a process that accurately corrects the color shift. Therefore, the color phase detection method has a problem from the viewpoint of the quality of a corrected image, real-time processing capability, and reduction in cost.

The problems that occur when using the color phase detection method may be solved by a method that utilizes multi-band filters (see JP-A-2005-286649, for example). For example, wavelength-separated filters R1 and B1 that differ in color are assigned to a right-pupil luminous flux, and wavelength-separated filters R2 and B2 that differ in color are assigned to a left-pupil luminous flux to obtain right and left phase difference images. In this case, it is necessary to provide the image sensor with multi-band (multi-wavelength band) color filters that implement color separation, and pixels assigned to each color filter that corresponds to each band. Therefore, each band image (separate wavelength band image) is necessarily sampled roughly, and the phase difference detection correlation accuracy deteriorates. Moreover, the resolution of the single-band image decreases due to rough sampling, and the resolution of the captured image decreases.

As described above, known phase detection AF methods have various problems (e.g., occurrence of a color shift, a decrease in resolution, the necessity for an advanced pixel defect correction process, a decrease in phase difference detection accuracy, the possibility that it is impossible to detect the phase difference, and the necessity for an image sensor provided with multi-band color filters).

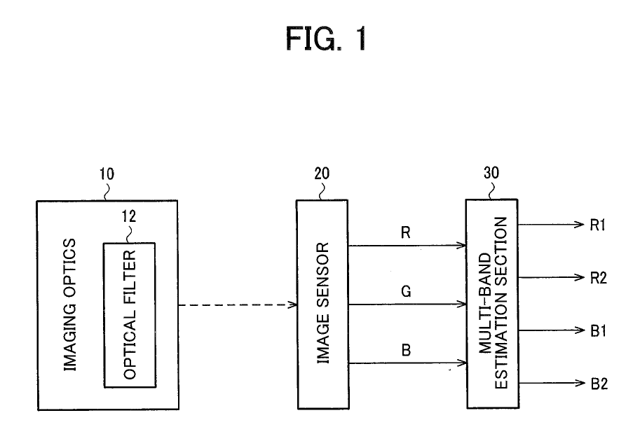

As illustrated in FIG. 1, an imaging device according to one embodiment of the invention includes an optical filter 12, an image sensor 20, and a multi-band estimation section 30. The optical filter 12 divides the pupil of an imaging optics 10 into a first pupil and a second pupil that differs in wavelength passband from the first pupil. The image sensor 20 includes a first-color (e.g., red) filter that has first transmittance characteristics, a second-color (e.g., green) filter that has second transmittance characteristics, and a third-color (e.g., blue) filter that has third transmittance characteristics. The multi-band estimation section 30 estimates component values R1, R2, B1, and B2 that respectively correspond to a first band, a second band, a third band, and a fourth band based on pixel values R, G, and B that respectively correspond to a first color, a second color, and a third color that form an image captured by the image sensor 20, the first band, the second band, the third band, and the fourth band being set based on the wavelength passband of the first pupil, the wavelength passband of the second pupil, the first transmittance characteristics, the second transmittance characteristics, and the third transmittance characteristics.

According to one embodiment of the invention, the first band, the second band, the third band, and the fourth band are set based on the wavelength passband of the first pupil, the wavelength passband of the second pupil, and the pixel values R, G, and B that respectively correspond to the first color, the second color, and the third color and are obtained by the image sensor 20 that includes the first-color filter, the second-color filter, and the third-color filter, and the component values R1, R2, B1, and B2 that correspond to the first band, the second band, the third band, and the fourth band are estimated based on the pixel values that respectively correspond to the first color, the second color, and the third color that form the image captured by the image sensor 20. This makes it possible to implement a multi-band imaging system without significantly changing an existing imaging system.

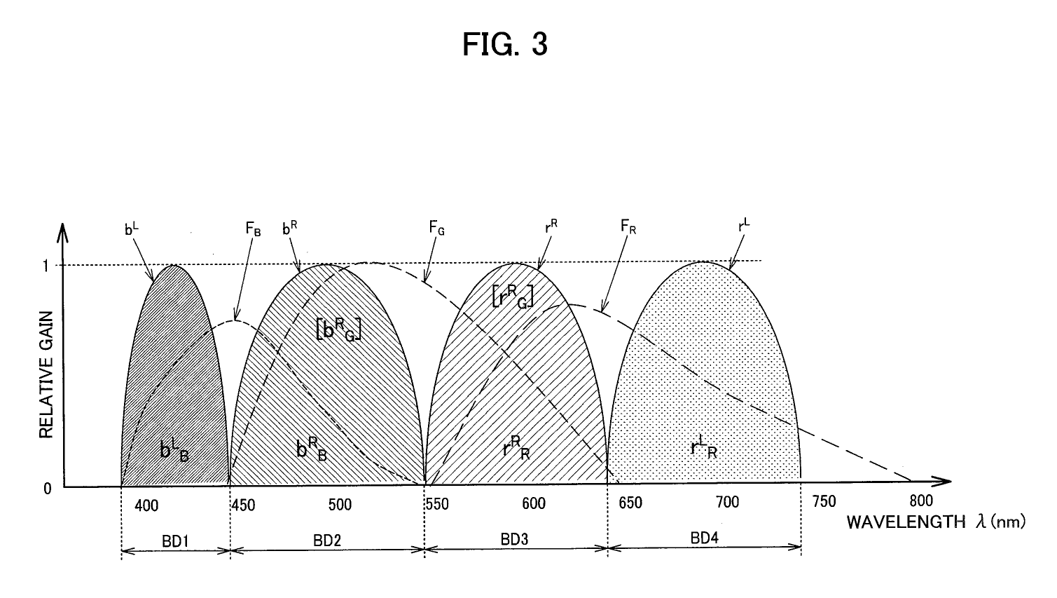

The above configuration is further described below taking the following embodiments as an example. The image sensor 20 is a single-chip RGB image sensor. Specifically, the image sensor 20 has a configuration in which a color filter that corresponds to a single color is provided to each pixel, and the pixels are disposed in a given arrangement (e.g., Bayer array). As illustrated in FIG. 3, the RGB wavelength bands (F_{B}, F_{G}, F_{R}) overlap each other. The overlapping characteristics are similar to those of color filters provided to a known image sensor, for example. Therefore, a known image sensor can be used without significantly changing the configuration thereof.

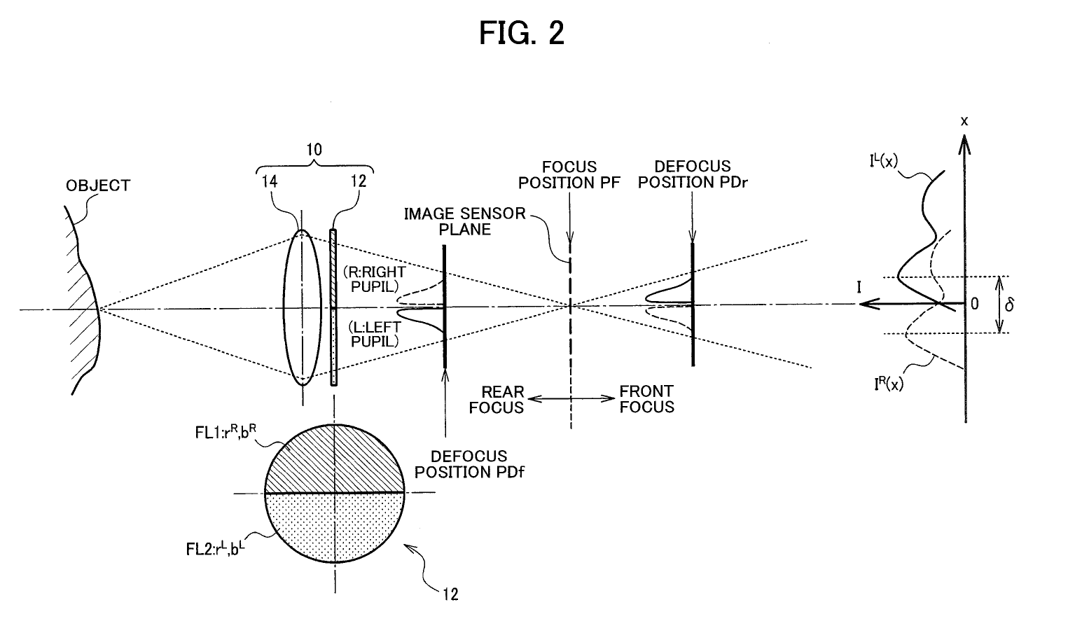

As illustrated in FIGS. 2 and 3, the bands (BD3 and BD2) that correspond to the component values R1 and B1 that differ in color are assigned to the right pupil (FL1), and the bands (BD4 and BD1) that correspond to the component values R2 and B2 that differ in color are assigned to the left pupil (FL2), for example. Specifically, the first band, the second band, the third band, and the fourth band are set based on the wavelength passband of the first pupil, the wavelength passband of the second pupil, the first transmittance characteristics of the first-color filter, the second transmittance characteristics of the second-color filter, and the third transmittance characteristics of the third-color filter. Since the R and G wavelength bands and the G and B wavelength bands of the image sensor 20 respectively overlap each other, the pixel values R=R1+R2, G=R2+B2, and B=B1+B2 can be acquired. The imaging device according to one embodiment of the invention performs the estimation process by utilizing the overlapping region to determine the 4-band component values R1, R2, B1, and B2 (r^{R}_{R}, r^{L}_{R}, b^{R}_{B}, b^{L}_{B}).

In this case, a right-pupil image (I^{R}(x)) can be formed by the component values R1 and B1 that correspond to the right pupil, and a left-pupil image (I^{L}(x)) can be formed by the component values R2 and B2 that correspond to the left pupil. The phase difference can be calculated by utilizing the right-pupil image and the left-pupil image. Since a normal RGB image sensor can be used as the image sensor 20, an RGB image having a normal resolution can be captured. Specifically, since it is unnecessary to provide color separation pixels (see above), it is possible to obtain an RGB image without decreasing the resolution of the captured image. Since the phase difference images can be obtained without decreasing resolution by demosaicing the RGB Bayer image, the phase difference detection accuracy can be improved. Since both the red band and the blue band are assigned to the first pupil and the second pupil, it is possible to suppress a color shift within the image at the defocus position.

According to one embodiment of the invention, a parallax imaging process (i.e., an imaging process that acquires three-dimensional information) can be implemented using a monocular system. Therefore, it is possible to acquire the phase difference information on a pixel basis through post-processing without significantly changing the configuration of the imaging optics and the structure of the image sensor. Since the R1 image, the R2 image, the B2 image, and the B1 image can be acquired, it is possible to acquire the right-pupil image and the left-pupil image by combining the spectral characteristics in various ways, and improve the detection range with respect to various spectral characteristics of the object. Examples of the application of one embodiment of the invention include a high-speed phase detection AF process, a stereoscopic image generation process using a monocular system, an object ranging process, and the like.

The imaging device may be configured as described below. Specifically, the imaging device may include the optical filter 12 divides the pupil of the imaging optics 10 into the first pupil and the second pupil that differs in wavelength passband from the first pupil, the image sensor 20 that includes the first-color filter that has the first transmittance characteristics, the second-color filter that has the second transmittance characteristics, and the third-color filter that has the third transmittance characteristics, a memory that stores information (e.g., a program and various types of data), and a processor (i.e., a processor including hardware) that operates based on the information stored in the memory. The processor is configured to implement a multi-band estimation process that estimates the component values R1, R2, B1, and B2 that respectively correspond to the first band, the second band, the third band, and the fourth band based on the pixel values R, G, and B that respectively correspond to the first color, the second color, and the third color that form an image captured by the image sensor 20, the first band, the second band, the third band, and the fourth band being set based on the wavelength passband of the first pupil, the wavelength passband of the second pupil, the first transmittance characteristics, the second transmittance characteristics, and the third transmittance characteristics.

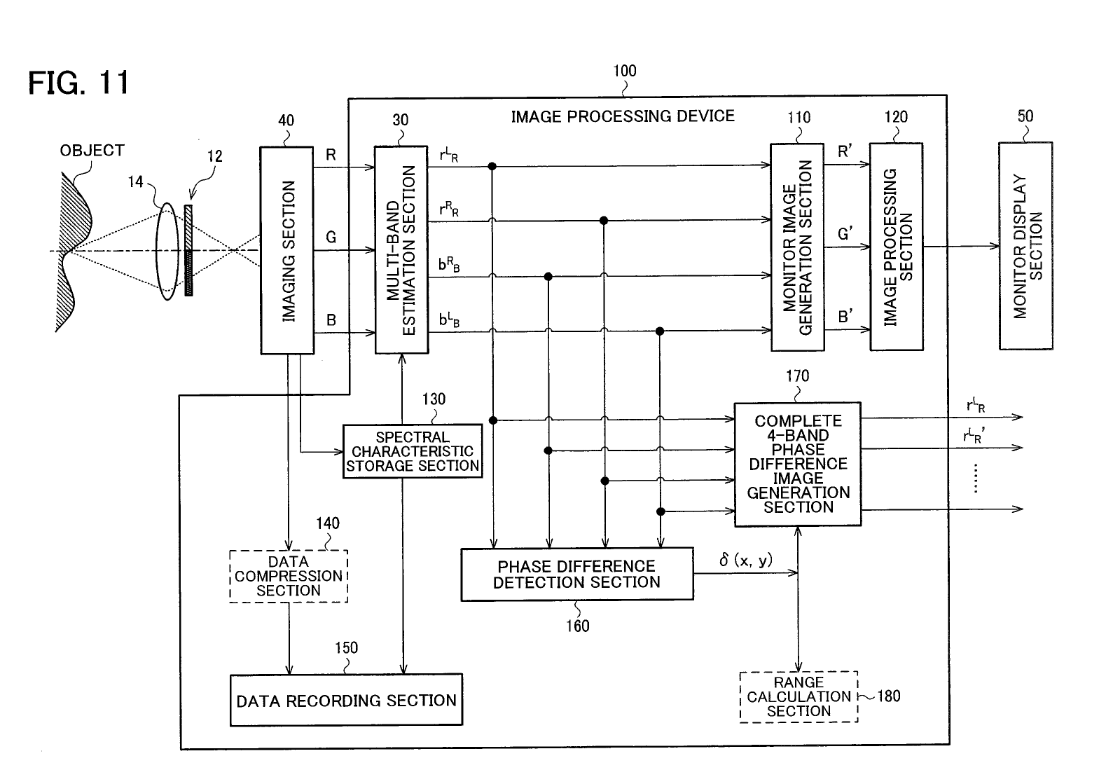

The processor may implement the function of each section by individual hardware, or may implement the function of each section by integrated hardware, for example. The processor may be a central processing unit (CPU), for example. Note that the processor is not limited to a CPU. Various other processors such as a graphics processing unit (GPU) or a digital signal processor (DSP) may also be used. The processor may be a hardware circuit that includes an ASIC. The memory may be a semiconductor memory (e.g., SRAM or DRAM), a register, a magnetic storage device (e.g., hard disk drive), or an optical storage device (e.g., optical disk device). For example, the memory stores a computer-readable instruction. Each section of the imaging device (i.e., the image processing device (e.g., the image processing device 100 illustrated in FIG. 11) included in the imaging device) is implemented by causing the processor to execute the instruction. The instruction may be an instruction included in an instruction set that is included in a program, or may be an instruction that causes a hardware circuit included in the processor to operate.

The operation according to the embodiments of the invention is implemented as described below, for example An image captured by the image sensor 20 is stored in the storage section. The processor reads the image from the storage section, and acquires the pixel values R, G, and B that respectively correspond to the first color, the second color, and the third color (of each pixel). The processor estimates the component values R1, R2, B1, and B2 that respectively correspond to the first band, the second band, the third band, and the fourth band based on the pixel values R, G, and B that respectively correspond to the first color, the second color, and the third color, and stores the estimated component values R1, R2, B1, and B2 that respectively correspond to the first band, the second band, the third band, and the fourth band in the storage section.

Each section of the imaging device (i.e., the image processing device (e.g., the image processing device 100 illustrated in FIG. 11) included in the imaging device) is implemented as a module of a program that operates on the processor. For example, the multi-band estimation section 30 is implemented as a multi-band estimation module that estimates the component values R1, R2, B1, and B2 that respectively correspond to the first band, the second band, the third band, and the fourth band based on the pixel values R, G, and B that respectively correspond to the first color, the second color, and the third color that form an image captured by the image sensor 20, the first band, the second band, the third band, and the fourth band being set based on the wavelength passband of the first pupil, the wavelength passband of the second pupil, the first transmittance characteristics, the second transmittance characteristics, and the third transmittance characteristics.

### 2. Basic Configuration

The embodiments of the invention are described in detail below. Note that the image sensor 20 is hereinafter appropriately referred to as “image sensor”. The transmittance characteristics {F_{R}, F_{G}, F_{B}} and {r^{R}, r^{L}, b^{R}, b^{L}} are functions of the wavelength λ, but the wavelength λ is omitted for convenience of explanation. The band component values {b^{L}_{B}, b^{R}_{B}, r^{L}_{R}, r^{R}_{R}} are not functions, but are values.

FIG. 2 illustrates a basic configuration example of the imaging optics 10 according to one embodiment of the invention. The imaging optics 10 includes an imaging lens 14 that forms an image of the object in the sensor plane of the image sensor 20, and the optical filter 12 that separates the band corresponding to the first pupil and the second pupil. Although an example in which the first pupil is the right pupil and the second pupil is the left pupil is described below, the configuration is not limited thereto. Specifically, the pupil need not necessarily be divided into the right pupil and the left pupil. The pupil is divided into the first pupil and the second pupil in an arbitrary direction that is perpendicular to the optical axis of the imaging optics.

The optical filter 12 includes a right-pupil filter FL1 (first filter) that has transmittance characteristics {b^{R}, r^{R}}, and a left-pupil filter FL2 (second filter) that has transmittance characteristics {b^{L}, r^{L}}. The transmittance characteristics {r^{R}, r^{L}, b^{R}, b^{L}} are set to have a comb-teeth configuration (as described later). The optical filter 12 is provided at the pupil position (e.g., aperture position) of the imaging optics 10. The filter FL1 corresponds to the right pupil, and the filter FL2 corresponds to the left pupil.

### 3. Band Division Method

FIG. 3 is a view illustrating the band division method. Note that the superscript suffix included in the symbol (e.g., b^{L}_{B}) that represents each component value represents whether light has passed through the right pupil “R” or the left pupil “L”, and the subscript suffix included in the symbol (e.g., b^{L}_{B}) that represents each component value represents whether light has passed through the red filter “R”, the green filter “G”, or the blue filter “B” of the image sensor 20.

As illustrated in FIG. 3, the first band BD1, the second band BD2, the third band BD3, and the fourth band BD4 correspond to the transmittance characteristics {r^{L}, r^{R}, b^{R}, b^{L}} of the optical filter 12. Specifically, the bands BD2 and BD3 (that are situated on the inner side in FIG. 3) are assigned to the right pupil, and the bands BD1 and BD4 (that are situated on the outer side in FIG. 3) are assigned to the left pupil. The component values {b^{L}_{B}, b^{R}_{B}, r^{L}_{R}, r^{R}_{R}} that correspond to the bands BD1 to BD4 are determined corresponding to the spectral characteristics of the imaging system.

FIG. 3 illustrates the transmittance characteristics {F_{R}, F_{G}, F_{B}} of the color filters of the image sensor as the spectral characteristics of the imaging system. Note that the spectral characteristics of the imaging system also include the spectral characteristics of the image sensor excluding the spectral characteristics of the color filters, the spectral characteristics of the optics, and the like. The following description is given on the assumption that the spectral characteristics of the image sensor and the like are included in the transmittance characteristics {F_{R}, F_{G}, F_{B}} of the color filters illustrated in FIG. 3 for convenience of explanation.

The transmittance characteristics {F_{R}, F_{G}, F_{B}} of the color filters overlap each other, and the bands are set corresponding to the overlapping state. Specifically, the band BD2 corresponds to the overlapping region of the transmittance characteristics {F_{B}, F_{G}} of the blue filter and the green filter, and the band BD3 corresponds to the overlapping region of the transmittance characteristics {F_{G}, F_{R}} of the green filter and the red filter. The band BD1 corresponds to the non-overlapping region of the transmittance characteristics F_{B} of the blue filter, and the band BD4 corresponds to the non-overlapping region of the transmittance characteristics F_{R} of the red filter. Note that the term “non-overlapping region” used herein refers to a region that does not overlap the transmittance characteristics of other color filters.

The bandwidths of the bands BD1 to BD4 are set taking account of the spectral characteristics of the optical filter 12, the spectral characteristics of the imaging optics, the RGB filter characteristics of the image sensor, and the sensitivity characteristics of the pixels so that the spectral components {r^{L}_{R}, r^{R}_{R}, b^{R}_{B}, b^{L}_{B}} are identical in terms of the pixel value when an ideal white object (i.e., an image having flat spectral characteristics) is captured, for example. Specifically, the bandwidths of the bands BD1 to BD4 need not necessarily be the bandwidth of the transmittance characteristics or the bandwidth of the overlapping region. For example, the band of the overlapping region of the transmittance characteristics {F_{G}, F_{B}} is about 450 to 550 nm, but need not necessarily be 450 to 550 nm as long as the band BD2 corresponds to the overlapping region of the transmittance characteristics {F_{G}, F_{B}}.

As illustrated in FIG. 2, the 4-band component values {r^{L}_{R}, r^{R}_{R}, b^{R}_{B}, b^{L}_{B}} form a left image I^{L}(x) and a right image I^{R}(x). For example, the left image I^{L}(x) and the right image I^{R}(x) may be formed as represented by the following expression (1), (2), or (3). Note that x is the position (coordinates) in the pupil division direction (e.g., the horizontal scan direction of the image sensor 20).

[I^{L}(x),I^{R}(x)]=[r^{L}_{R}(x),r^{R}_{R}(x)] (1)

[I^{L}(x),I^{R}(x)]=[b^{L}_{B}(x),b^{R}_{B}(x)] (2)

[I^{L}(x),I^{R}(x)]=[r^{L}_{R}(x)+b^{L}_{B}(x),r^{R}_{R}(x)+b^{R}_{B}(x)] (3)

### 4. Multi-Band Estimation Process

The multi-band estimation process that estimates the 4-band component values {r^{L}_{R}, r^{R}_{R}, b^{R}_{B}, b^{L}_{B}} from the 3-color pixel values {R, G, B} is described below. Although an example in which the multi-band estimation process is applied to the case where the pupil is divided is described below, the multi-band estimation process may also be applied to the case where the pupil is not divided. Specifically, a 4-band image can also be obtained from an image captured without providing the optical filter 12 by utilizing a similar estimation method.

As illustrated in FIG. 2, light that has passed through the right pupil and the left pupil of the optical filter 12 is captured by the image sensor that includes a Bayer color filter array. A demosaicing process is performed on the Bayer image to generate RGB images (i.e., an image in which each pixel has an R pixel value, an image in which each pixel has a G pixel value, and an image in which each pixel has a B pixel value). Note that the image sensor 20 may be a three-chip primary-color (RGB) image sensor. Specifically, it suffices that the image sensor 20 be able to capture an image that corresponds to the first color, an image that corresponds to the second color, and an image that corresponds to the third color.

The spectral characteristics {r^{R}, r^{L}, b^{R}, b^{L}} of the right pupil and the left pupil are assigned corresponding to the overlapping regions of the spectral characteristics {F_{R}, F_{G}, F_{B}} of the color filters (see FIG. 3). Therefore, the RGB values acquired at each pixel of the image sensor and the 4-band component values satisfy the relationship represented by the following expression (4).

R=r^{R}_{R}+r^{L}_{R},

G=r^{R}_{G}+b^{R}_{G},

B=b^{R}_{B}+b^{L}_{B} (4)

The sensitivity with respect to the spectral characteristics {F_{B}, F_{G}, F_{R}} differs in the overlapping region. Specifically, the blue pixel and the green pixel (F_{B}, F_{G}) differ in sensitivity with respect to the blue light (b^{R}) that has passed through the right pupil, and the green pixel and the red pixel (F_{G}, F_{R}) differ in sensitivity with respect to the red light (r^{R}) that has passed through the right pupil. When the sensitivity ratio (gain ratio) of the green pixel to the red pixel is represented by a coefficient α, and the sensitivity ratio (gain ratio) of the blue pixel to the green pixel is represented by a coefficient β, the following expression (5) is satisfied.

r^{R}_{G}=α·r^{R}_{R},

b^{R}_{G}=β·b^{R}_{B} (5)

The coefficients α and β are determined by the spectral characteristics of the imaging optics, the optical filter 12, the color filters of the image sensor, and the pixels of the image sensor. When α=β=1, the component values {r^{R}_{G}, b^{R}_{G}} are represented by the following expression (6) in view of the expression (5).

r^{R}_{G}=r^{R}_{R},

b^{R}_{G}=b^{R}_{B} (6)

The expression (4) can be rewritten into the following expression (7) in view of the expression (6).

R=r^{R}_{R}+r^{L}_{R},

G=r^{R}_{R}+b^{R}_{B},

B=b^{R}_{B}+b^{L}_{B} (7)

Transforming the expression (7) yields the following expression (8).

G−R=b^{R}_{B}−r^{L}_{R},

r^{R}_{R}=R−r^{L}_{R},

b^{L}_{B}=B−b^{R}_{B} (8)

When the component value r^{L}_{R} in the expression (8) is an unknown (unknown variable), the relational expression of the 4-band component values {r^{L}_{R}, r^{R}_{R}, b^{R}_{B}, b^{L}_{B}} is given by the following expression (9). Note that the component value r^{L}_{R} need not necessarily set to be an unknown. Any of the 4-band component values may be set to be an unknown.

r^{L}_{R}=(unknown),

r^{R}_{R}=R−r^{L}_{R},

b^{R}_{B}=(G−R)−r^{L}_{R},

b^{L}_{B}=B−(G−R)+r^{L}_{R} (9)

A plurality of combinations of solutions exist for the 4-band component values {r^{L}_{R}, r^{R}_{R}, b^{R}_{B}, b^{L}_{B}}. The phase difference images {r^{L}_{R}, r^{R}_{R}} or {b^{R}_{B}, b^{L}_{B}} due to light that has passed through the right pupil and the left pupil can be calculated by estimating the maximum likelihood combination pattern from the plurality of combinations of solutions. A method that estimates the maximum likelihood solutions is described below.

### 5. Solution Estimation Method

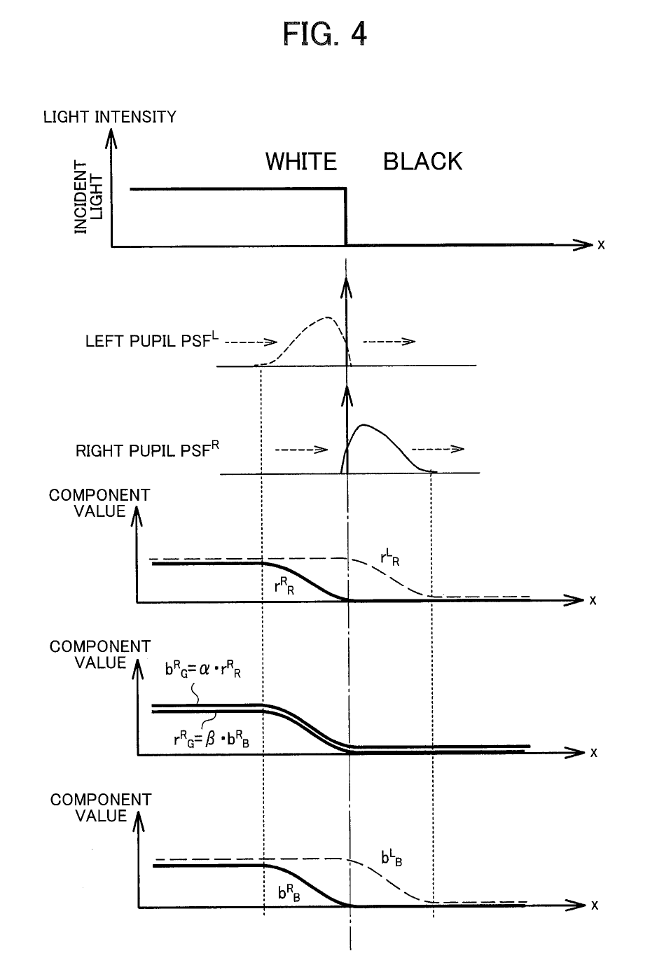

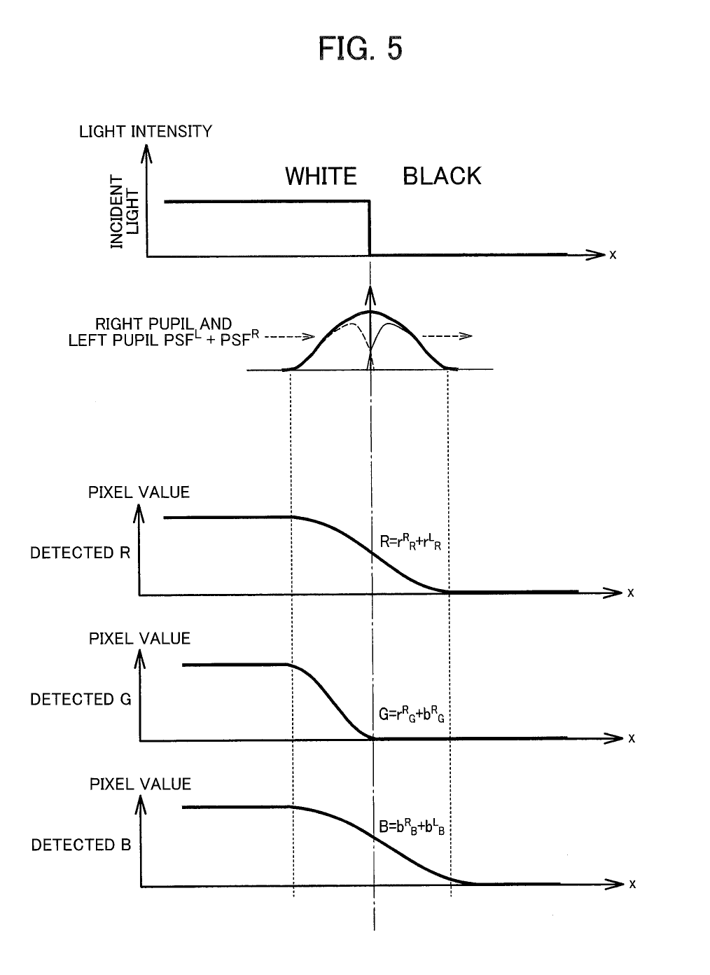

FIGS. 4 and 5 schematically illustrate a change in the RGB pixel values and the 4-band component values at the edge. FIG. 4 illustrates the edge profile of the captured image and a change in the 4-band spectral pattern. FIG. 5 illustrates the RGB pattern (detected pixel values) that corresponds to the 4-band spectral pattern.

The 4-band spectral pattern obtained by pupil division is set to have a high correlation with the acquired RGB pattern. Specifically, since the component values {r^{R}_{R}, b^{R}_{B}} that correspond to the pixel value G pass through an identical pupil (right pupil), there is no phase difference (image shift) between the image represented by the component value r^{R}_{R} and the image represented by the component value b^{R}_{B} (see FIG. 4). Since the component values {r^{R}_{R}, b^{R}_{B}} belong to the adjacent wavelength bands, it is considered that the component values {r^{R}_{R}, b^{R}_{B}} have an almost similar profile and are synchronized with each other with respect to a normal object. When the pixel value G is synchronized with the component values {r^{R}_{R}, b^{R}_{B}}, it is considered that the RGB pattern and the 4-band pattern have a highly similar relationship (a special pattern in which the component values r^{R}_{R} and b^{R}_{B} alternately increase and decrease is excluded).

Therefore, the maximum likelihood 4-band spectral pattern can be estimated by selecting the 4-band spectral pattern that is considered to have the highest similarity with the RGB pattern acquired on a pixel basis from the plurality of solutions.

The details thereof are described below with reference to FIGS. 4 to 7. As illustrated in FIG. 4, the image represented by each component value is a convolution of point spread functions PSF^{L} and PSF^{R} that correspond to the left pupil and the right pupil and the profile of the object. Therefore, a phase difference occurs between the red component values {r^{R}_{R}, r^{L}_{R}} and the blue component values {b^{R}_{B}, b^{L}_{B}} that are divided in band corresponding to the right pupil and the left pupil. On the other hand, a phase difference does not occur between the green component values {r^{R}_{R}, b^{R}_{B}} that are assigned to only the right pupil.

As illustrated in FIG. 5, the RGB values of the captured image are the sum of the above component values. The R image and the B image are the sum of the phase difference images, and are averaged in shift with respect to the edge. On the other hand, the G image is the sum of the images that have no phase difference and correspond to the right pupil, and is shifted to the left with respect to the edge.

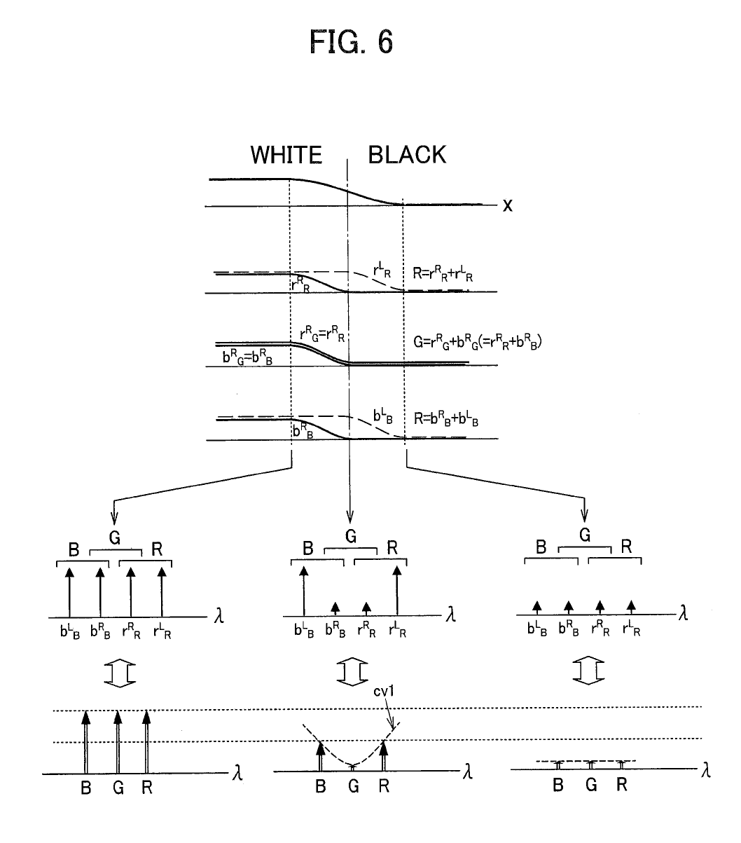

The captured image has the 4-band component values and the RGB pixel values illustrated in FIG. 6 corresponding to the edge and either side of the edge. The pixel values {B, G, R} are acquired by capturing the object, and the 4-band component values {b^{L}_{B}, b^{R}_{B}, r^{R}_{R}, r^{L}_{R}} are estimated from the pixel values {B, G, R}. Since the pixel value pattern and the component value pattern are similar to each other, it is possible to accurately estimate the 4-band component values {b^{L}_{B}, b^{R}_{B}, r^{R}_{R}, r^{L}_{R}}.

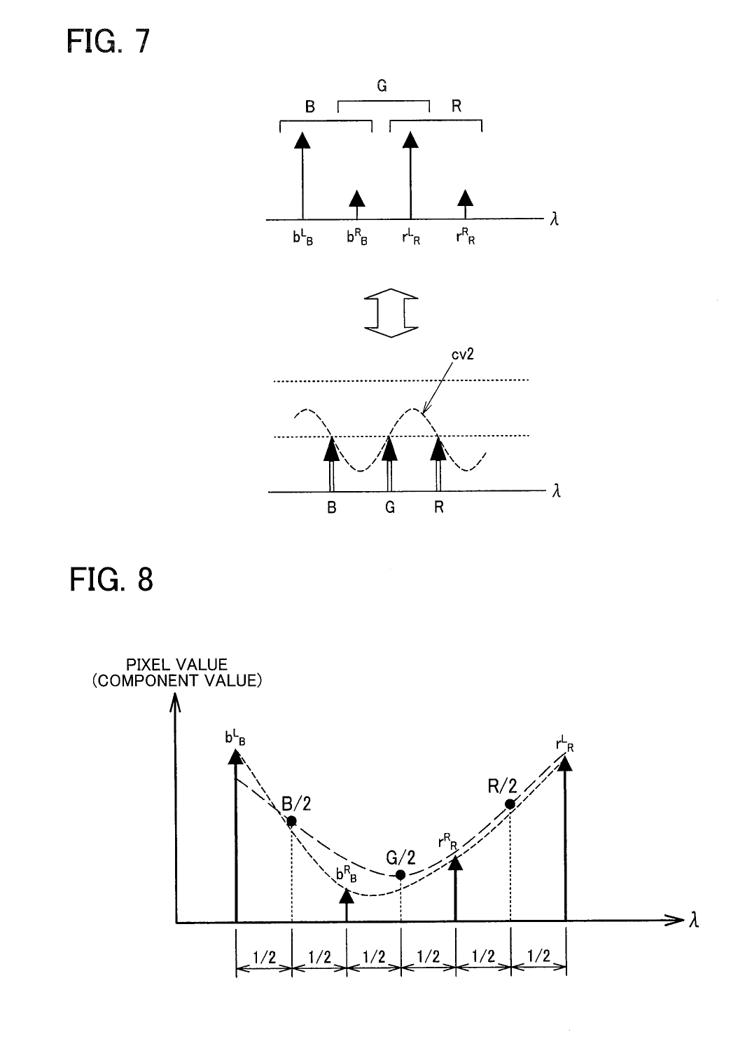

If the four bands are sequentially assigned to the left pupil, the right pupil, the left pupil, and the right pupil, the component values {b^{L}_{B}, b^{R}_{B}, r^{L}_{R}, r^{R}_{R}} have a “high-low-high-low” pattern at the edge, and the pixel values {B, G, R} have a pattern in which the pixel values {B, G, R} have an identical magnitude (see FIG. 7). A pattern similar to the 4-band component value pattern is obtained if the estimation result represented by the curve cv2 is obtained from the pixel values {B, G, R}. However, since the pixel values {B, G, R} have a flat pattern, it is considered that the estimation accuracy deteriorates.

According to one embodiment of the invention, the pixel values {B, G, R} have a pattern in which the pixel value {G} is smaller than the pixel values {B, R} at the edge, and the curve cv1 that is fitted to this pattern is similar to the pattern of the component values {b^{L}_{B}, b^{R}_{B}, r^{R}_{R}, r^{L}_{R}} (see FIG. 6). This is because the two intermediate bands are assigned to the right pupil. Specifically, it is possible to implement a highly accurate multi-band estimation process by sequentially assigning the four bands to the left pupil, the right pupil, the right pupil, and the left pupil.

### 6. First Estimation Method

A method that determines the 4-band component values from the relational expression of the 4-band component values represented by the expression (9) and the RGB pixel values is described below.

An evaluation function E(r^{L}_{R}) is used to determine the similarity between the RGB pattern and the 4-band spectral pattern. The component value r^{L}_{R} is set to be an unknown in the same manner as in the expression (9). For example, when the RGB pixel values and the 4-band component values have the relationship illustrated in FIG. 8, the evaluation function E(r^{L}_{R}) is represented by the following expression (10).

E(r^{L}_{R})=e_{R}+e_{G}+e_{B},

e_{R}=(r^{L}_{R}−R/2)²+(r^{R}_{R}−R/2)²,

e_{G}=(r^{R}_{R}−G/2)²+(b^{R}_{B}−G/2)²,

e_{B}=(b^{R}_{B}−B/2)²+(b^{L}_{B}−B/2)² (10)

The evaluation function E(r^{L}_{R}) is calculated as a function of the unknown r^{L}_{R} by substituting the relational expression represented by the expression (9) into the expression (10). The unknown r^{L}_{R} is changed, and the unknown r^{L}_{R} at which the ranges of the component values {r^{L}_{R}, r^{R}_{R}, b^{R}_{B}, b^{L}_{B}} represented by the following expression (11) are satisfied and the evaluation function E(r^{L}_{R}) becomes a minimum is determined to be the solution. Note that N in the expression (11) is the maximum number of quantization bits defined as a variable.

0≦r^{L}_{R}<2^{N},

0≦r^{R}_{R}<2^{N},

0≦b^{R}_{B}<2^{N},

0≦b^{L}_{B}<2^{N} (11)

When the unknown r^{L}_{R} has been determined, the determined value is substituted into the expression (9) to derive the 4-band component values {r^{L}_{R}, r^{R}_{R}, b^{R}_{B}, b^{L}_{B}}.

According to the first estimation method, since the evaluation function E(r^{L}_{R}) is a quadratic function of the unknown r^{L}_{R}, the minimum value of the evaluation function E(r^{L}_{R}) is easily calculated as a function of the pixel values {R, G, B}, and the 4-band component values {r^{L}_{R}, r^{R}_{R}, b^{R}_{B}, b^{L}_{B}} are calculated using a simple expression. If the ranges of the 4-band component values {r^{L}_{R}, r^{R}_{R}, b^{R}_{B}, b^{L}_{B}} (see the expression (11)) are exceeded using the expression, the minimum value of the evaluation function E(r^{L}_{R}) must be calculated within the ranges.

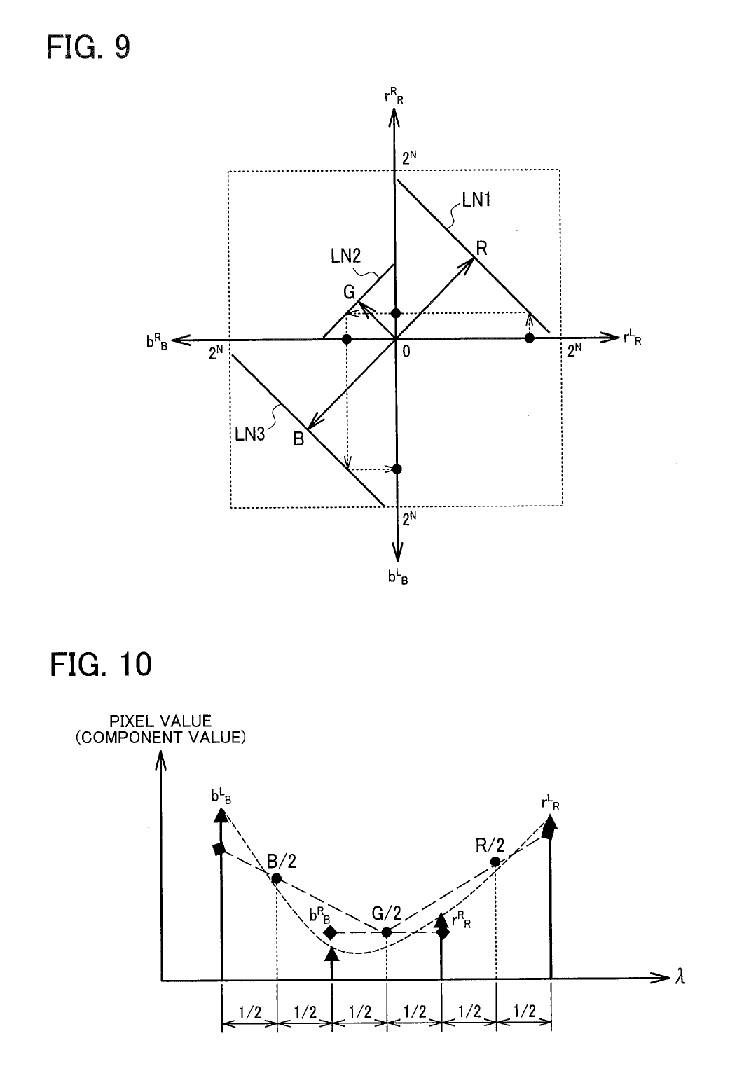

FIG. 9 illustrates the relationship between the 4-band component values obtained by the estimation process and the RGB pixel values. For example, since the pixel value R is R=r^{L}_{R}+r^{R}_{R}=(r^{L}_{R}, r^{R}_{R})·(1, 1), the pixel value R is obtained by mapping the vector (r^{L}_{R}, r^{R}_{R}) in the (1, 1)-direction. Specifically, the vector (r^{L}_{R}, r^{R}_{R}) has a magnitude along the straight line LN1 that passes through the pixel value R. Likewise, the straight lines LN2 and LN3 are determined corresponding to the pixel values G and B, and the 4-band component values {r^{L}_{R}, r^{R}_{R}, b^{R}_{B}, b^{L}_{B}} are determined to be present along the straight lines LN1 to LN3.

In this case, the domain of definition of the 4-band component values {r^{L}_{R}, r^{R}_{R}, b^{R}_{B}, b^{L}_{B}} is limited by the domain of definition of the pixel values {R, G, B} (e.g., 0≦r^{L}_{R} and r^{R}_{R}<2^{N} when 0≦R=r^{L}_{R}+r^{R}_{R}<2^{N}). Therefore, the component values are estimated so that the domain of definition is not exceeded.

### 7. Second Estimation Method

The following estimation method may be used instead of the above estimation method. Specifically, the RGB pattern is interpolated or extrapolated (see FIG. 8) to calculate interpolated component values (interpolated 4-band component value pattern) {r^{L}_{R}′, r^{R}_{R}′, b^{R}_{B}′, b^{L}_{B}′} (see the following expression (12)).

r^{L}_{R}′=(3/2)·(R/2−G/2)+G/2,

r^{R}_{R}′=(1/2)·(R/2+G/2),

b^{R}_{B}′=(1/2)·(B/2+G/2),

b^{L}_{B}′=(3/2)·(R/2−G/2)+G/2 (12)

In this case, the evaluation function E(r^{L}_{R}) is represented (defined) by the following expression (13).

E(r^{L}_{R})=(r^{L}_{R}−r^{L}_{R}′)²+(r^{R}_{R}−r^{R}_{R}′)²+(b^{R}_{B}−b^{R}_{B}′)²+(b^{L}_{B}−b^{L}_{B}′)² (13)

The expressions (9) and (12) are substituted into the expression (13). The unknown r^{L}_{R} is changed, and the unknown r^{L}_{R} that minimizes the evaluation function E(r^{L}_{R}) is determined to be the solution. When the unknown r^{L}_{R} has been determined, the determined value r^{L}_{R} is substituted into the expression (9) to derive the 4-band component values {r^{L}_{R}, r^{R}_{R}, b^{R}_{B}, b^{L}_{B}}.

### 8. Third Estimation Method

The following estimation method may be used instead of the above estimation method. As illustrated in FIG. 10, it is considered that the component values r^{R}_{R}′ and b^{R}_{B}′ are equal to the pixel value G based on the RGB pattern, and the remaining component values are interpolated values calculated by extrapolation. In this case, interpolated component values (interpolated 4-band component value pattern) {r^{L}_{R}′, r^{R}_{R}′, b^{R}_{B}′, b^{L}_{B}′} are calculated using the following expression (14).

r^{L}_{R}′=(3/2)·(R/2−G/2)+G/2,

r^{R}_{R}′=G/2,

b^{R}_{B}′=G/2,

b^{L}_{B}′=(3/2)·(B/2−G/2)+G/2 (14)

The evaluation function E(r^{L}_{R}) is represented (defined) by the following expression (15).

E(r^{L}_{R})=(r^{L}_{R}−r^{L}_{R}′)²+(r^{R}_{R}−r^{R}_{R}′)²+(b^{R}_{B}−b^{R}_{B}′)²+(b^{L}_{B}−b^{L}_{B}′)² (15)

The expressions (9) and (14) are substituted into the expression (15). The unknown r^{L}_{R} is changed, and the unknown r^{L}_{R} that minimizes the evaluation function E(r^{L}_{R}) is determined to be the solution. When the unknown r^{L}_{R} has been determined, the determined value r^{L}_{R} is substituted into the expression (9) to derive the 4-band component values {r^{L}_{R}, r^{R}_{R}, b^{R}_{B}, b^{L}_{B}}.

### 9. Modifications of Estimation Method

The 4-band spectral pattern may be estimated from the RGB pattern using various other methods.

For example, an interpolated 4-band spectral pattern may be calculated from the RGB pixel values using Lagrange interpolation. Alternatively, a regression curve that is fitted to the RGB pattern may be calculated by fitting on the assumption that the 4-band component values are represented by a quadratic curve.

The 4-band spectral pattern may also be estimated using a statistical method. Specifically, the target is set to the object image, and the 4-band spectral pattern is generated from a known image of the target. The 4-band spectral pattern having the highest statistical generation probability is calculated in advance corresponding to each RGB pattern of the known image, and a look-up table that represents the relationship therebetween is provided. The look-up table is stored in a memory (not illustrated in the drawings) or the like, and the 4-band spectral pattern that corresponds to the acquired RGB pattern is determined by referring to the look-up table.

### 10. Imaging Device

FIG. 11 illustrates a detailed configuration example of the imaging device that implements the multi-band estimation process according to one embodiment of the invention. The imaging device includes the optical filter 12, the imaging lens 14, an imaging section 40, a monitor display section 50, and an image processing device 100. Note that the same elements as those described above with reference to FIG. 1 are indicated by the reference signs (symbols), and description thereof is appropriately omitted.

The imaging section 40 includes the image sensor 20 and an imaging processing section. The imaging processing section performs an imaging operation control process, an analog pixel signal A/D conversion process, an RGB Bayer image demosaicing process, and the like, and outputs an RGB image (pixel values {R, G, B}).

The image processing device 100 performs the multi-band estimation process according to one embodiment of the invention, and various types of image processing. The image processing device 100 includes a multi-band estimation section 30, a monitor image generation section 110, an image processing section 120, a spectral characteristic storage section 130, a data compression section 140, a data recording section 150, a phase difference detection section 160, a complete 4-band phase difference image generation section 170, and a range calculation section 180.

The spectral characteristic storage section 130 stores data that represents the transmittance characteristics {F_{R}, F_{G}, F_{B}} of the color filters of the image sensor 20. The multi-band estimation section 30 determines the coefficients α and β (see the expression (5)) based on the data (that represents the transmittance characteristics {F_{R}, F_{G}, F_{B}}) read from the spectral characteristic storage section 130. The multi-band estimation section 30 performs the multi-band estimation process based on the coefficients α and β to estimate the 4-band component values {r^{L}_{R}, r^{R}_{R}, b^{R}_{B}, b^{L}_{B}}.

The phase difference detection section 160 detects the phase difference δ(x, y) between the left image I^{L} and the right image I^{R}. The left image I^{L} and the right image I^{R} are formed using the 4-band component values {r^{L}_{R}, r^{R}_{R}, b^{R}_{B}, b^{L}_{B}} (see the expressions (1) to (3)). The phase difference may be calculated corresponding to each of the expressions (1) to (3), or the phase differences calculated corresponding to the expressions (1) to (3) may be averaged. Alternatively, the phase difference may be calculated corresponding to one of the expressions (1) to (3) (e.g., the phase difference is calculated corresponding to the expression (1) in an area in which the component R is large). The phase difference δ(x, y) is calculated on a pixel basis. Note that (x, y) represents the position (coordinates) within the image. For example, x corresponds to the horizontal scan direction, and y corresponds to the vertical scan direction.

The range calculation section 180 performs a three-dimensional measurement process based on the detected phase difference δ(x, y). Specifically, the range calculation section 180 calculates the distance to the object at each pixel position (x, y) from the phase difference δ(x, y) to acquire three-dimensional shape information about the object. The details thereof are described later.

The complete 4-band phase difference image generation section 170 generates a complete 4-band phase difference image based on the phase difference δ(x, y). Specifically, the complete 4-band phase difference image generation section 170 generates the left-pupil component values {r^{L}_{R}′, b^{L}_{B}′} corresponding to the band for which only the right-pupil component values {r^{R}_{R}, b^{R}_{B}} have been obtained. The complete 4-band phase difference image generation section 170 generates the right-pupil component values {r^{R}_{R}′, b^{R}_{B}′} corresponding to the band for which only the left-pupil component values {r^{L}_{R}, b^{L}_{B}} have been obtained. The details thereof are described later.

The monitor image generation section 110 generates a monitor image (pixel values {R′, G′, B′}) from the 4-band component values {r^{L}_{R}, r^{R}_{R}, b^{R}_{B}, b^{L}_{B}}. The monitor image is a display image for which a color shift has been simply corrected using the method described later, for example.

The image processing section 120 performs image processing on the monitor image, and outputs the resulting monitor image to the monitor display section 50. For example, the image processing section 120 performs a process (e.g., noise reduction process and grayscale correction process) that improves the image quality.

The data compression section 140 performs a compression process on captured image data output from the imaging section 40. The data recording section 150 records the compressed captured image data, and the data that represents the transmittance characteristics {F_{R}, F_{G}, F_{B}} of the color filters. The original data obtained by the image sensor may be recorded as the captured image data, or data that represents the complete 4-band phase difference image may be recorded as the captured image data. The amount of data recorded in the data recording section 150 can be reduced by recording the original data. The data recorded in the data recording section 150 can be used for the multi-band estimation process during the post-capture process. The post-capture process may be performed by the image processing device 100 included in the imaging device, or may be performed by an image processing device that is provided separately from the imaging device.

### 11. Image Processing Device

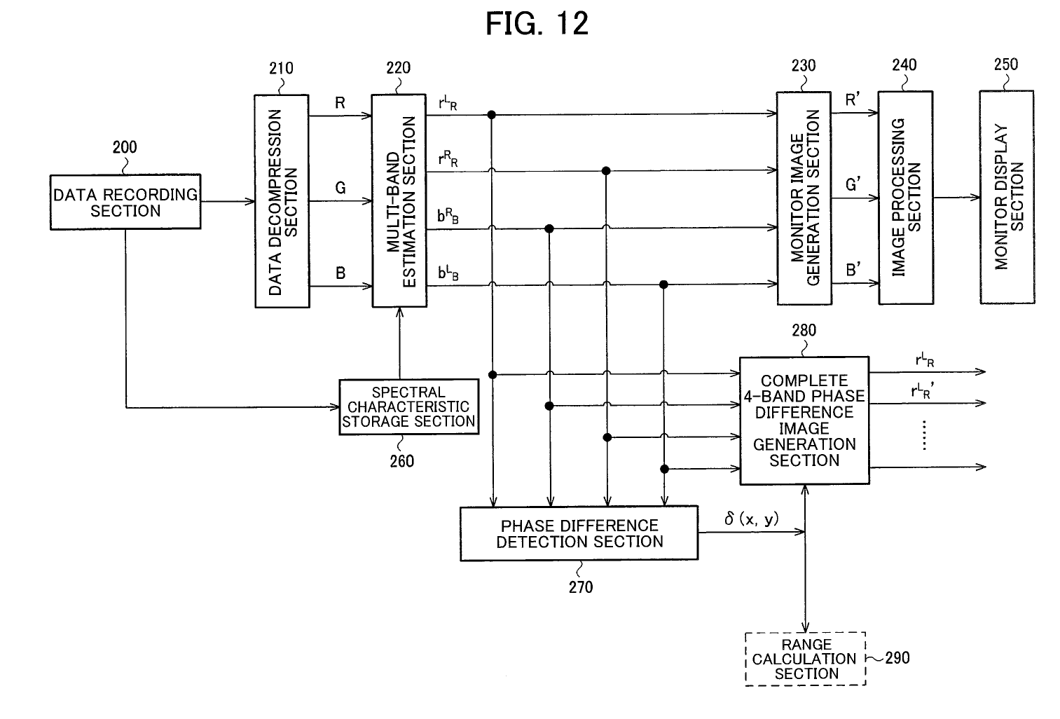

FIG. 12 illustrates a configuration example of an image processing device that is provided separately from the imaging device. The image processing device includes a data recording section 200, a data decompression section 210, a multi-band estimation section 220, a monitor image generation section 230, an image processing section 240, a monitor display section 250, a spectral characteristic storage section 260, a phase difference detection section 270, a complete 4-band phase difference image generation section 280, and a range calculation section 290. The image processing device may be an information processing device such as a PC, for example.

The data recording section 200 is implemented by an external storage device (e.g., memory card), for example. The data recording section 200 stores the RGB image data and the transmittance characteristic data recorded by the imaging device. The data decompression section 210 decompresses the RGB image data compressed by the imaging device. The spectral characteristic storage section 260 acquires the transmittance characteristic data from the data recording section 200, and stores the transmittance characteristic data.

The configuration and the operation of the multi-band estimation section 220, the monitor image generation section 230, the image processing section 240, the monitor display section 250, the phase difference detection section 270, the complete 4-band phase difference image generation section 280, and the range calculation section 290 are the same as described above in connection with those included in the imaging device illustrated in FIG. 11.

According to one embodiment of the invention, the first band BD1 and the second band BD2 correspond to the band of the first transmittance characteristics F_{B}, the second band BD2 and the third band BD3 correspond to the band of the second transmittance characteristics F_{G}, and the third band BD3 and the fourth band BD4 correspond to the band of the third transmittance characteristics F_{R}, as described above with reference to FIG. 3 and the like. The first pupil (filter FL1) allows the second band BD2 and the third band BD3 (transmittance characteristics b^{R} and r^{R}) to pass through, and the second pupil (filter FL2) allows the first band BD1 and the fourth band BD4 (transmittance characteristics b^{L} and r^{L}) to pass through, as described above with reference to FIG. 2 and the like.

According to this configuration, since the first band BD1, the second band BD2, the third band BD3, and the fourth band BD4 are selectively assigned to the first pupil and the second pupil, the image I^{R} that has passed through the first pupil and the image I^{L} that has passed through the second pupil can be formed from the estimated component values {b^{L}_{B}, b^{R}_{B}, r^{R}_{R}, r^{L}_{R}} (see the expressions (1) to (3)). This makes it possible to calculate the phase difference δ from the image I^{R} that corresponds to the first pupil and the image I^{L} that corresponds to the second pupil, and implement a ranging process, a three-dimensional measurement process, a phase detection AF process, and the like based on the phase difference δ. Since the two intermediate bands among the four bands are assigned to the first pupil, the pattern {B, G, R} and the pattern {b^{L}_{B}, b^{R}_{B}, r^{R}_{R}, r^{L}_{R}} can be made similar to each other, as described above with reference to FIG. 6 and the like. This makes it possible to improve the 4-band component value estimation accuracy.

According to one embodiment of the invention, the second band BD2 corresponds to the overlapping region of the first transmittance characteristics F_{B} and the second transmittance characteristics F_{G}, and the third band BD3 corresponds to the overlapping region of the second transmittance characteristics F_{G} and the third transmittance characteristics F_{R}, as described above with reference to FIG. 3 and the like.

According to this configuration, the pixel values {B, G} share the component value b^{R}_{B} (b^{R}_{G}) that corresponds to the second band BD2, and the pixel values {G, R} share the component value r^{R}_{R} (r^{R}_{G}) that corresponds to the third band BD3 (see the expressions (4) and (5)). Therefore, it is possible to express the 4-band component values {b^{L}_{B}, b^{R}_{B}, r^{R}_{R}, r^{L}_{R}} using the relational expression that represents the relationship between the unknown r^{L}_{R} and the pixel values {B, G, R}, and determine the 4-band component values {b^{L}_{B}, b^{R}_{B}, r^{R}_{R}, r^{L}_{R}} by estimating the unknown r^{L}_{R}.

Specifically, the multi-band estimation section 30 (220) calculates the relational expression (expression (9)) that represents the relationship between the component values that respectively correspond to the first band BD1, the second band BD2, the third band BD3, and the fourth band BD4 based on the pixel value B that corresponds to the first color that is obtained by adding up the component values {b^{L}_{B}, b^{R}_{B}} that correspond to the first band BD1 and the second band BD2, the pixel value G that corresponds to the second color that is obtained by adding up the component values {b^{R}_{B}, r^{R}_{R}} that correspond to the second band BD2 and the third band BD3, and the pixel value R that corresponds to the third color that is obtained by adding up the component values {r^{R}_{R}, r^{L}_{R}} that correspond to the third band BD3 and the fourth band BD4, and estimates the component values that respectively correspond to the first band BD1, the second band BD2, the third band BD3, and the fourth band BD4 based on the relational expression.

Therefore, the pixel value that corresponds to each color can be represented by the value obtained by adding up the component values that correspond to the bands that correspond to each color based on the relationship between the first band BD1, the second band BD2, the third band BD3, the fourth band BD4, the first color, the second color, and the third color (see the expression (6)). Since the pixel value that corresponds to each color includes a shared (common) component value, the 4-band component values {b^{L}_{B}, b^{R}_{B}, r^{R}_{R}, r^{L}_{R}} can be expressed using one unknown r^{L}_{R} by deleting the shared (common) component value by subtraction or the like (see the expressions (5) to (9)).

The multi-band estimation section 30 (220) calculates the relational expression using the component value that corresponds to the first band BD1, the component value that corresponds to the second band BD2, the component value that corresponds to the third band BD3, or the component value that corresponds to the fourth band BD4 as an unknown (r^{L}_{R}), and calculates the error evaluation value E(r^{L}_{R}) that represents an error between the component values {b^{L}_{B}, b^{R}_{B}, r^{R}_{R}, r^{L}_{R}} that respectively correspond to the first band BD1, the second band BD2, the third band BD3, and the fourth band BD4, and the pixel values {B, G, R} that respectively correspond to the first color, the second color, and the third color (see the expressions (10) to (15)). The multi-band estimation section 30 (220) determines the unknown r^{L}_{R} that minimizes the error evaluation value E(r^{L}_{R}), and determines the component values {b^{L}_{B}, b^{R}_{B}, r^{R}_{R}, r^{L}_{R}} that respectively correspond to the first band BD1, the second band BD2, the third band BD3, and the fourth band BD4 based on the determined unknown r^{L}_{R} and the relational expression (expression (9)).

This makes it possible to evaluate the degree of similarity between the component values {b^{L}_{B}, b^{R}_{B}, r^{R}_{R}, r^{L}_{R}} and the pixel values {B, G, R} using the error evaluation value E(r^{L}_{R}), and determine the unknown r^{L}_{R} at which the degree of similarity becomes a maximum.

According to one embodiment of the invention, the multi-band estimation section 30 (220) acquires the parameters (i.e., the coefficients α and β in the expression (5)) that are set based on the transmittance characteristics {b^{R}, r^{R}, b^{L}, r^{L}} of the first pupil and the second pupil and the first to third transmittance characteristics {F_{B}, F_{G}, F_{R}}, and estimates the component values {b^{L}_{B}, b^{R}_{B}, r^{R}_{R}, r^{L}_{R}} that respectively correspond to the first band BD1, the second band BD2, the third band BD3, and the fourth band BD4 based on the parameters.

Specifically, the gain ratio (coefficient β) of the first and second transmittance characteristics {F_{B}, F_{G}} within the second band BD2, and the gain ratio (coefficient α) of the second and third transmittance characteristics {F_{G}, F_{R}} within the third band BD3 are used as the parameters.

According to this configuration, it is possible to adjust the gain ratio of the component value b^{R}_{B} (b^{R}_{G}) that is shared by the pixel values {B, G} and the component value r^{R}_{R} (r^{R}_{G}) that is shared by the pixel values {G, R} by utilizing the parameters (coefficients α and β) based on the spectral characteristics (transmittance characteristics). This makes it possible to accurately delete the shared component value by subtraction, and improve the 4-band component value estimation accuracy.

The multi-band estimation section 30 (220) may acquire known information (e.g., look-up table) that statistically links the pixel values {B, G, R} that respectively correspond to the first color, the second color, and the third color with the component values {b^{L}_{B}, b^{R}_{B}, r^{R}_{R}, r^{L}_{R}} that respectively correspond to the first band BD1, the second band BD2, the third band BD3, and the fourth band BD4. The multi-band estimation section 30 (220) may calculate the component values {b^{L}_{B}, b^{R}_{B}, r^{R}_{R}, r^{L}_{R}} that respectively correspond to the first band BD1, the second band BD2, the third band BD3, and the fourth band BD4 that correspond to the pixel values {B, G, R} that respectively correspond to the first color, the second color, and the third color that form the image captured by the image sensor 20, from the known information.

This makes it possible to estimate the 4-band component values based on the known information that is statistically generated from a known image. For example, when the application (imaging target) is determined in advance (e.g., microscope), it is considered that the occurrence frequency of the 4-band component values with respect to the RGB pixel values is biased with regard to the imaging target. In such a case, it is possible to implement an accurate multi-band estimation process by calculating the 4-band component values having a high statistical occurrence frequency corresponding to each of the RGB pixel values.

### 12. Monitor Image Generation Process

The details of the process performed by the monitor image generation sections 110 and 230 are described below.

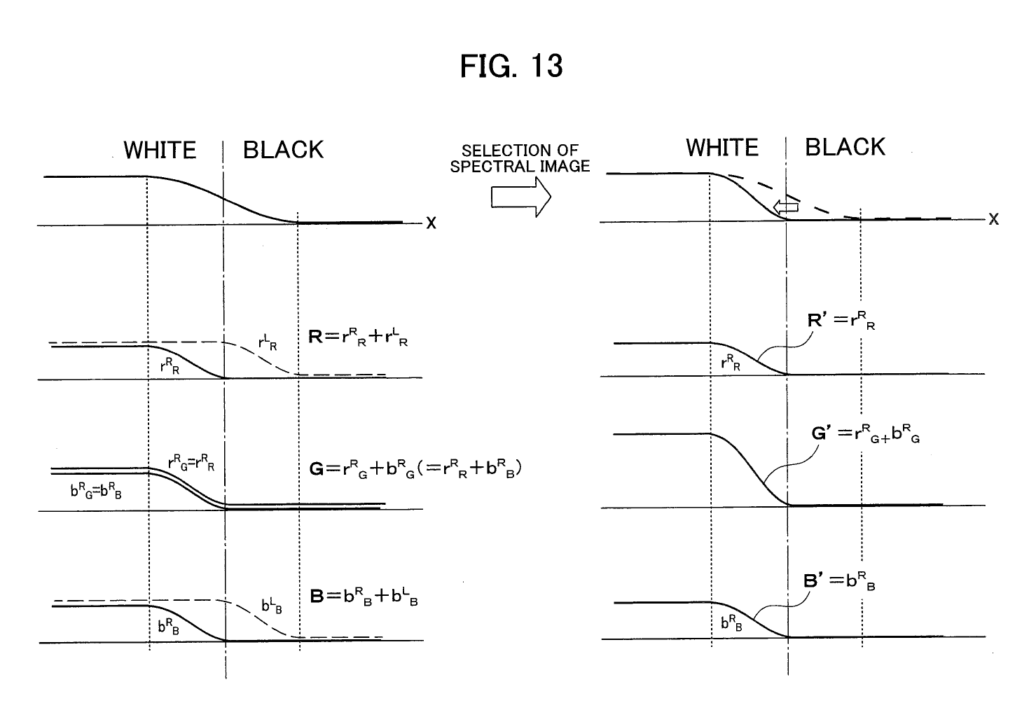

As illustrated in FIG. 13, a real-time monitor image is generated using only a single-phase image formed by light that has passed through the right pupil, or only a single-phase image formed by light that has passed through the left pupil. Specifically, the monitor display RGB image {R′, G′, B′} is generated using only the component values {r^{R}_{R}, b^{R}_{B}} that form the G image (see the following expression (16)). Alternatively, the monitor display RGB image {R′, G′, B′} is generated using only the component values {r^{L}_{R}, b^{L}_{B}} (see the following expression (17)). Note that FIG. 13 corresponds to the following expression (18).

R′=r^{R}_{R}, G′=r^{R}_{G}+b^{R}_{G}, B′=b^{R}_{B} (16)

R′=r^{L}_{R}, G′=r^{L}_{R}+b^{L}_{B}, B′=b^{L}_{B} (17)

FIG. 13 illustrates the primary color profile of the monitor image when an edge image is acquired by the image sensor. For example, when an image is formed by light that has passed through the right pupil, the R′G′B′ values are generated using only the right-pupil image, and a color shift (phase shift) between the primary colors rarely occurs. Since the wavelength band of the color that can be displayed is limited, the color gamut narrows. However, the resulting image can be used as a monitor image for which high quality is not required.

Whether to display the monitor image generated using the expression (16) or the monitor image generated using the expression (17) may be determined (selected) as described below, for example. Specifically, the expression (16) may be used when the component values {r^{R}_{R}, b^{R}_{B}} are large on average corresponding to each image frame, and the expression (17) may be used when the component values {r^{L}_{R}, b^{L}_{B}} are large on average corresponding to each image frame.

According to one embodiment of the invention, a display image generation section (monitor image generation section 110) generates a display image based on the component values that correspond to the bands among the first band BD1, the second band BD2, the third band BD3, and the fourth band BD4 that have passed through the first pupil (filter FL1) or the second pupil (filter FL2) (see the expression (16) or (17)).

This makes it possible to generate the display image using the component values that correspond to the bands that have passed through the first pupil or the second pupil. Specifically, since the display image is generated so that a phase difference does not occur between the RGB colors, it is possible to display the display image while suppressing a color shift. Since only one pupil image is extracted, it is possible to simplify the process, and generate the monitor image at a low load even when the imaging device has relatively low processing capacity.

### 13. Complete 4-Band Phase Difference Image Generation Process

The details of the process performed by the complete 4-band phase difference image generation sections 170 and 280 are described below.

When the image sensor acquires an image through the spectral pupil division process, the image sensor can acquire only the left-pupil image or the right-pupil image. Specifically, it is necessary to restore the other pupil image in order to acquire each synthesized image (right-left pupil synthesized image) to generate a complete color image.

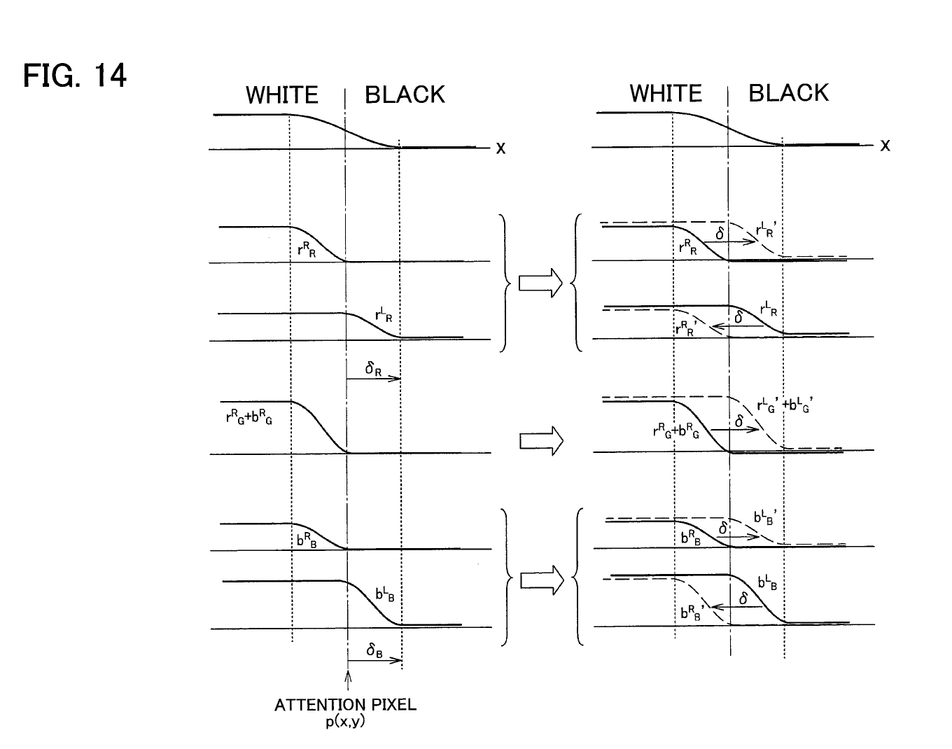

As illustrated in FIG. 14, the right-pupil component value r^{R}_{R} that forms the R image makes a pair with the left-pupil component value r^{L}_{R}′, and the left-pupil component value r^{L}_{R} that forms the R image makes a pair with the right-pupil component value r^{R}_{R}′. The right-pupil component value r^{R}_{G}+b^{R}_{G} that forms the G image makes a pair with the left-pupil component value r^{R}_{G}′+b^{R}_{G}′. The right-pupil component value b^{R}_{B} that forms the B image makes a pair with the left-pupil component value and the left-pupil component value b^{L}_{B} that forms the B image makes a pair with the right-pupil component value b^{R}_{B}′.

A phase difference (shift amount) h is obtained corresponding to the attention pixel (pixel of interest) p(x, y) by performing correlation calculations on the image that corresponds to the component value r^{R}_{R} and the image that corresponds to the component value r^{L}_{R}, and a phase difference δ_{B} is obtained corresponding to the attention pixel p(x, y) by performing correlation calculations on the image that corresponds to the component value b^{R}_{B} and the image that corresponds to the component value b^{L}_{B}. The phase difference δ_{R} and the phase difference δ_{B} are almost identical since the phase difference δ_{R} and the phase difference δ_{B} occur due to the right pupil and the left pupil. Therefore, the phase difference δ that is common to RGB is calculated by calculating the average value of the phase difference δ_{R} and the phase difference δ₁₃ (see the following expression (18)).

δ=(δ_{R}+δ_{B})/2 (18)

The relationship represented by the following expression (19) is satisfied using the phase difference δ. A complete right pupil-left pupil 4-band image is obtained using the expression (19).

r^{L}_{R}′(x)=r^{R}_{R}(x−δ),

r^{R}_{R}′(x)=r^{L}_{R}(x+δ),

r^{L}_{G}′(x)+b^{L}_{G}′(x)=r^{R}_{G}(x−δ)+b^{R}_{G}(x−δ),

b^{L}_{B}′(x)=b^{R}_{B}(x−δ),

b^{R}_{B}′(x)=b^{L}_{B}(x+δ) (19)

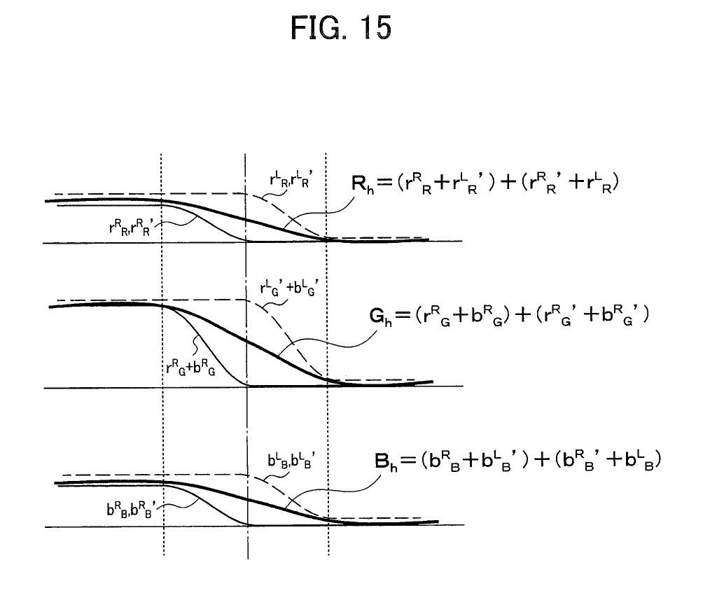

The pixel values {Rₕ, Gₕ, Bₕ} of the completely restored image are generated using the component values calculated using the expression (19) (see the following expression (20)). The completely restored image is free from a phase difference (color shift) between the colors and a phase difference with respect to the edge (see FIG. 15).

Rₕ=(r^{R}_{R}+r^{L}_{R}′)+(r^{R}_{R}′+r^{L}_{R}),

Gₕ=(r^{R}_{G}+b^{R}_{G})+(r^{R}_{G}′+b^{R}_{G}′),

Bₕ=(b^{R}_{B}+b^{L}_{B}′)+(b^{R}_{B}′+b^{L}_{B}) (20)

Note that the phase differences δ_{R}, δ_{B}, and δ are calculated corresponding to each arbitrary position (x, y) on the image sensor, but the coordinates (x, y) are omitted.

According to one embodiment of the invention, the phase difference detection section 160 (270) detects the phase difference δ between a first image and a second image based on the first image and the second image, the first image being formed by the component values {r^{R}_{R}, b^{R}_{B}} that correspond to the bands among the first band BD1, the second band BD2, the third band BD3, and the fourth band BD4 that have passed through the first pupil (right pupil), and the second image being formed by the component values {r^{L}_{R}, b^{L}_{B}} that correspond to the bands among the first band BD1, the second band BD2, the third band BD3, and the fourth band BD4 that have passed through the second pupil (left pupil).

This makes it possible to detect the phase difference 6 by utilizing pupil division using the optical filter 12, and utilize the phase difference 6 for various applications (e.g., phase detection AF process and three-dimensional measurement process).

According to one embodiment of the invention, a third image (component values {r^{L}_{R}′, b^{L}_{B}′}) and a fourth image (component values {r^{R}_{R}′, b^{R}_{B}′}) are generated, the third image being generated by shifting the first image (component values {r^{R}_{R}, b^{R}_{B}}) based on the phase difference δ, and the fourth image being generated by shifting the second image (component values {r^{L}_{R}, b^{L}_{B}}) based on the phase difference δ. An image that corresponds to the case where each of the first band BD1, the second band BD2, the third band BD3, and the fourth band BD4 has passed through the first pupil, and an image that corresponds to the case where each of the first band BD1, the second band BD2, the third band BD3, and the fourth band BD4 has passed through the second pupil, are thus generated.

This makes it possible to generate a right pupil-left pupil image corresponding to each band from the 4-band images (when each band has passed through the right pupil or the left pupil). Therefore, it is possible to generate a restored image that is free from a color shift (see the expression (20)). The above process can be applied to various applications such as a three-dimensional (3D) display process, a multi-band image display process, and a three-dimensional shape analysis process.

14. Method that Calculates Distance from Phase Difference

A method that calculates the distance to the object from the phase difference is described below. This ranging method is used for the process performed by the range calculation sections 180 and 290, for example. A phase detection AF control process may be performed using the defocus amount calculated as described below.

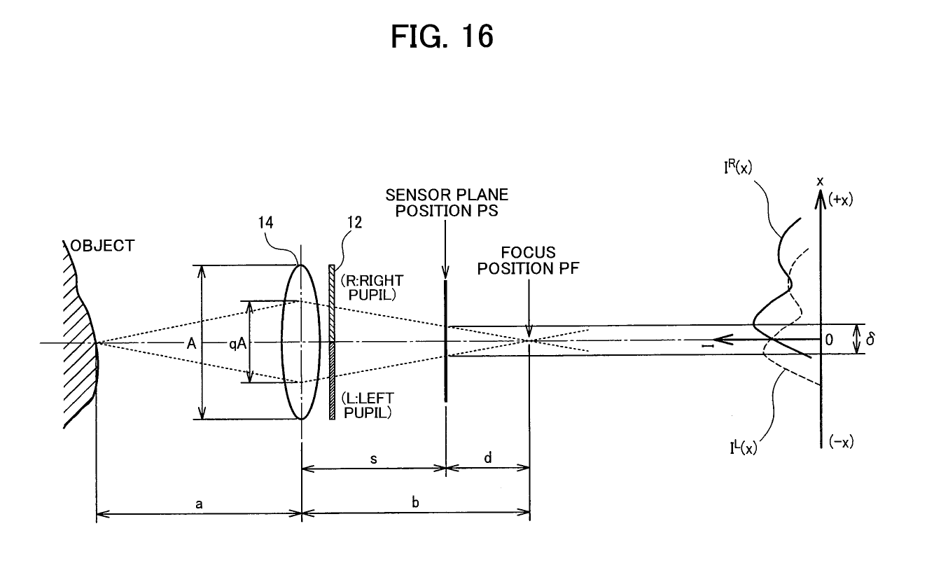

As illustrated in FIG. 16, the maximum aperture diameter is referred to as A, the distance between the center of gravity of the right pupil and the center of gravity of the left pupil with respect to the aperture diameter A is referred to as q×A, the distance from the center of the imaging lens 14 to a sensor plane PS of the image sensor along the optical axis is referred to as s, and the phase difference between the right-pupil image I^{R}(x) and the left-pupil image I^{L}(x) in the sensor plane PS is referred to as δ. In this case, the following expression (21) is satisfied through triangulation.

q×A:δ=b:d,

b=s+d (21)

Note that q is a coefficient that satisfies 0≦q≦1, and q×A also changes depending on the aperture. s is a value detected by a lens position detection sensor. b is the distance from the center of the imaging lens 14 to a focus position PF along the optical axis. The phase difference δ is calculated by correlation calculations. The defocus amount d is calculated by the following expression (22) in view of the expression (21).

d=(δ×s)/{(q×A)−δ} (22)

The distance a is a distance that corresponds to the focus position PF (i.e., the distance from the imaging lens 14 to the object along the optical axis). When the composite focal length of an imaging optics that is formed by a plurality of lenses is referred to as f, the following expression (23) is normally satisfied.

(1/a)+(1/b)=1/f (23)

The distance b is calculated by the expression (21) using the defocus amount d calculated by the expression (22) and the value s that is detected by a lens position detection sensor, and the distance b and the composite focal length f determined by the imaging optical configuration are substituted into the expression (23) to calculate the distance a. Since the distance a that corresponds to an arbitrary pixel position can be calculated, it is possible to measure the distance to the object, and measure the three-dimensional shape of the object.

The phase detection AF process is performed as described below. For example, when FIG. 16 is a top view illustrating the imaging device (in the direction perpendicular to the pupil division direction), x is the coordinate axis in the horizontal direction (pupil division direction). The phase difference δ along the coordinate axis x is defined to be a positive value or a negative value with respect to the right-pupil image I^{R}(x) or the left-pupil image I^{L}(x), and whether the sensor plane PS is situated forward or backward with respect to the focus position PF is determined based on whether the phase difference δ is a positive value or a negative value. When the positional relationship between the sensor plane PS and the focus position PF has been determined, it is possible to easily determine the direction in which the focus lens should be moved in order to cause the sensor plane PS to coincide with the focus position PF.

After the defocus amount d has been calculated, and whether the phase difference δ is a positive value or a negative value has been determined, the focus lens is driven so that the defocus amount d becomes 0. Since the color is divided in the horizontal direction using the right pupil and the left pupil, the focusing target area in the horizontal direction is selected from the captured image, and correlation calculations are performed. Since the color division direction is not necessarily the horizontal direction, the correlation calculation direction may be appropriately set taking account of the setting conditions (division direction) for the right-left band separation optical filter. The target area for which the defocus amount d is calculated need not necessarily be part of the captured image, but may be the entire captured image. In this case, a plurality of defocus amounts d are calculated. Therefore, it is necessary to perform a process that determines the final defocus amount using a given evaluation function.

The embodiments to which the invention is applied and the modifications thereof have been described above. Note that the invention is not limited to the above embodiments and the modifications thereof. Various modifications and variations may be made of the above embodiments and the modifications thereof without departing from the scope of the invention. A plurality of elements described in connection with the above embodiments and the modifications thereof may be appropriately combined to implement various configurations. For example, some elements may be omitted from the elements described in connection with the above embodiments and the modifications thereof. Some of the elements described in connection with different embodiments or modifications thereof may be appropriately combined. The configuration and the operation of the imaging device and the image processing device, and the methods (imaging method and image processing method) for operating the imaging device and the image processing device are not limited to those described in connection with the above embodiments. Various modifications and variations may be made. Specifically, various modifications and applications are possible without materially departing from the novel teachings and advantages of the invention. Any term cited with a different term having a broader meaning or the same meaning at least once in the specification and the drawings can be replaced by the different term in any place in the specification and the drawings.

What is claimed is:

1. An imaging device comprising:
an optical filter that divides a pupil of an imaging optics into a first pupil and a second pupil, the second pupil differing in wavelength passband from the first pupil;
an image sensor that includes a first-color filter that has first transmittance characteristics, a second-color filter that has second transmittance characteristics, and a third-color filter that has third transmittance characteristics; and
a processor comprising hardware,
the processor being configured to implement a multi-band estimation process that estimates component values that respectively correspond to a first band, a second band, a third band, and a fourth band based on pixel values that respectively correspond to a first color, a second color, and a third color that form an image captured by the image sensor, the first band, the second band, the third band, and the fourth band being set based on the wavelength passband of the first pupil, the wavelength passband of the second pupil, the first transmittance characteristics, the second transmittance characteristics, and the third transmittance characteristics.

2. The imaging device as defined in claim 1,
the first band and the second band corresponding to a band of the first transmittance characteristics, the second band and the third band corresponding to a band of the second transmittance characteristics, and the third band and the fourth band corresponding to a band of the third transmittance characteristics, and
the first pupil allowing the second band and the third band to pass through, and the second pupil allowing the first band and the fourth band to pass through.

3. The imaging device as defined in claim 2,
the second band corresponding to an overlapping region of the first transmittance characteristics and the second transmittance characteristics, and the third band corresponding to an overlapping region of the second transmittance characteristics and the third transmittance characteristics.

4. The imaging device as defined in claim 2,
the processor being configured to implement the multi-band estimation process that calculates a relational expression that represents a relationship between the component values that respectively correspond to the first band, the second band, the third band, and the fourth band based on the pixel value that corresponds to the first color that is obtained by adding up the component values that respectively correspond to the first band and the second band, the pixel value that corresponds to the second color that is obtained by adding up the component values that respectively correspond to the second band and the third band, and the pixel value that corresponds to the third color that is obtained by adding up the component values that respectively correspond to the third band and the fourth band, and estimates the component values that respectively correspond to the first band, the second band, the third band, and the fourth band based on the relational expression.

5. The imaging device as defined in claim 4,
the processor being configured to implement the multi-band estimation process that calculates the relational expression using the component value that corresponds to the first band, the component value that corresponds to the second band, the component value that corresponds to the third band, or the component value that corresponds to the fourth band as an unknown, calculates an error evaluation value that represents an error between the component values that respectively correspond to the first band, the second band, the third band, and the fourth band that are represented by the relational expression, and the pixel values that respectively correspond to the first color, the second color, and the third color, determines the unknown that minimizes the error evaluation value, and determines the component values that respectively correspond to the first band, the second band, the third band, and the fourth band based on the determined unknown and the relational expression.

6. The imaging device as defined in claim 2,
the processor being configured to implement the multi-band estimation process that acquires parameters that are set based on transmittance characteristics of the first pupil and the second pupil, the first transmittance characteristics, the second transmittance characteristics, and the third transmittance characteristics, and estimates the component values that respectively correspond to the first band, the second band, the third band, and the fourth band based on the parameters.

7. The imaging device as defined in claim 6,
the parameters being a gain ratio of the first transmittance characteristics and the second transmittance characteristics within the second band, and a gain ratio of the second transmittance characteristics and the third transmittance characteristics within the third band.

8. The imaging device as defined in claim 1,
the processor being configured to implement the multi-band estimation process that acquires known information that statistically links the pixel values that respectively correspond to the first color, the second color, and the third color with the component values that respectively correspond to the first band, the second band, the third band, and the fourth band, and calculates the component values that respectively correspond to the first band, the second band, the third band, and the fourth band that correspond to the pixel values that respectively correspond to the first color, the second color, and the third color that form the image captured by the image sensor, from the known information.

9. The imaging device as defined in claim 1, further comprising:
the processor being configured to implement a phase difference detection process that detects a phase difference between a first image and a second image based on the first image and the second image, the first image being formed by the component values that correspond to bands among the first band, the second band, the third band, and the fourth band that have passed through the first pupil, and the second image being formed by the component values that correspond to bands among the first band, the second band, the third band, and the fourth band that have passed through the second pupil.

10. The imaging device as defined in claim 9, further comprising:
the processor being configured to implement a phase difference image generation process that generates an image that corresponds to a case where each of the first band, the second band, the third band, and the fourth band has passed through the first pupil, and an image that corresponds to a case where each of the first band, the second band, the third band, and the fourth band has passed through the second pupil, by generating a third image and a fourth image, the third image being generated by shifting the first image based on the phase difference, and the fourth image being generated by shifting the second image based on the phase difference.

11. The imaging device as defined in claim 1,
the processor being configured to implement a display image generation process that generates a display image based on the component values that correspond to bands among the first band, the second band, the third band, and the fourth band that have passed through the first pupil or the second pupil.

12. An imaging device comprising:
an optical filter that divides a pupil of an imaging optics into a first pupil and a second pupil, the second pupil differing in wavelength passband from the first pupil; and
an image sensor that includes a first-color filter that has first transmittance characteristics, a second-color filter that has second transmittance characteristics, and a third-color filter that has third transmittance characteristics, and
the first pupil allowing a first band and a fourth band to pass through, and the second pupil allowing a second band and a third band to pass through, when the first band and the second band corresponding to a band of the first transmittance characteristics, the second band and the third band corresponding to a band of the second transmittance characteristics, and the third band and the fourth band corresponding to a band of the third transmittance characteristics.

13. An image processing device comprising:
a processor comprising hardware,
the processor being configured to implement:
an image acquisition process that acquires an image captured by an image sensor, the image sensor including a first-color filter that has first transmittance characteristics, a second-color filter that has second transmittance characteristics, and a third-color filter that has third transmittance characteristics; and
a multi-band estimation process that estimates component values that respectively correspond to a first band, a second band, a third band, and a fourth band based on pixel values that respectively correspond to a first color, a second color, and a third color that form the image,
the first band and the second band corresponding to a band of the first transmittance characteristics, the second band and the third band corresponding to a band of the second transmittance characteristics, and the third band and the fourth band corresponding to a band of the third transmittance characteristics.

14. The image processing device as defined in claim 13,
the processor being configured to implement:
the image acquisition process that acquires the image obtained by capturing light that has passed through an optical filter using the image sensor, the optical filter dividing a pupil of an imaging optics into a first pupil and a second pupil, the second pupil differing in wavelength passband from the first pupil, and
the first pupil allowing the first band and the fourth band to pass through, and the second pupil allowing the second band and the third band to pass through.

15. An imaging method comprising:
capturing light that has passed through an optical filter using an image sensor, the optical filter dividing a pupil of an imaging optics into a first pupil and a second pupil, the second pupil differing in wavelength passband from the first pupil, and the image sensor including a first-color filter that has first transmittance characteristics, a second-color filter that has second transmittance characteristics, and a third-color filter that has third transmittance characteristics; and
estimating component values that respectively correspond to a first band, a second band, a third band, and a fourth band based on pixel values that respectively correspond to a first color, a second color, and a third color that form an image captured by the image sensor, the first band, the second band, the third band, and the fourth band being set based on the wavelength passband of the first pupil, the wavelength passband of the second pupil, the first transmittance characteristics, the second transmittance characteristics, and the third transmittance characteristics.
